(19) United States
(12) Patent Application Publication
(10) Pub. No.: US 2021/0211830 A1
(43) Pub. Date: Jul. 8, 2021

(54) RADIO CHANNEL ACCESS BASED ON COUNTRY CODES

(71) Applicant: HEWLETT-PACKARD DEVELOPMENT COMPANY, L.P., Spring, TX (US)

(72) Inventors: I-Chen LIN, Taipei (CN); Han-Kuang CHANG, Taipei (CN); Yi-Kang HSIEH, Taipei (CN)

(73) Assignee: HEWLETT-PACKARD DEVELOPMENT COMPANY, L.P., Houston, TX (US)

(21) Appl. No.: 16/075,620

(22) PCT Filed: Feb. 14, 2017
(86) PCT No.: PCT/US2017/017775

§ 371 Date: Aug. 4, 2018

(51) Int. Cl. H04W 4/02; H04W 48/18; H04W 48/20; H04W 72/08

(52) U.S. Cl. CPC H04W 4/02; H04W 72/085; H04W 48/20; H04W 48/18

(57) ABSTRACT

In some examples, a mobile device can provide radio channel access based on country codes by determining a time zone from an operating system (OS) of the mobile device, determining a country of the mobile device based on the time zone, receiving respective country codes from a plurality of access points (APs) in communication with the mobile device, and enabling access to an alternate radio channel from a default radio channel based on a comparison of the country of the mobile device to respective countries corresponding to the country codes.

### BACKGROUND

Under the Institute of Electrical and Electronics Engineers (IEEE) 802.11 specifications for implementing wireless local area network (WLAN) communications there are various distinct frequency ranges. Each distinct frequency range may be divided into various radio channels. Individual countries may apply their own regulations in regulating the use of these radio channels.

### BRIEF DESCRIPTION OF THE DRAWINGS

FIG. 1 illustrates a diagram of an example of a mobile device consistent with the disclosure.

FIG. 2 illustrates a diagram of an example of a system suitable for radio channel access based on country codes consistent with the disclosure.

FIG. 3 illustrates an example of a method for radio channel access based on country codes consistent with the disclosure.

FIG. 4 illustrates an example flow chart for radio channel access based on country codes consistent with the disclosure.

### DETAILED DESCRIPTION

Commerce on a global scale has created the desire for mobile devices utilizing wireless technology such as wireless local area network (WLAN) technology to comply with regulations that may vary based on the countries where mobile devices are being sold. That is, a particular radio channel on which a mobile device may communicate can vary depending upon the particular country of the mobile device (e.g., which country a mobile device is located and being used in). In particular, mobile devices that utilize the Institute of Electrical and Electronics Engineers (IEEE) 802.11ad or IEEE 802.11ay protocols operating on the 60 gigahertz (GHz) frequency band are subject to regulation of the radio channel with which the mobile devices use for communication, as described herein.

Devices using such regulated radio channels may be sold and used in one country with specified radio channel regulations and later, used and/or resold in a country with different radio channel regulations. It may be difficult to manufacture and market devices that comply with radio channel regulations on a global basis due to the global movement of devices.

Regulation of the radio channel with which mobile devices use for communication may result in latency based on different mobile devices using a same radio channel. Radio channel access based on country codes can allow for more bandwidth availability for communication of mobile devices. As used herein, a mobile device refers to a device such as a laptop, notebook, tablet, smart phone, personal digital assistant (PDA), smart glasses, and/or a wrist-worn device (e.g., a smart watch), among other types of mobile devices.

A mobile device, as described herein, can operate in a radio channel. For example, the mobile device can operate in a radio channel of a 60 GHz frequency band. As used herein, the 60 GHz band refers to a frequency band defined by IEEE 802.11 protocols. For example, the mobile device can operate in channel two of the 60 GHz band as defined by IEEE 802.11 protocols.

A mobile device may operate in a radio channel in compliance with a specific country's WLAN radio channel regulations. For example, the United States Federal Communications Commission (FCC) restricts the use of a mobile device operating in the United States from using channel four in the 60 GHz frequency band.

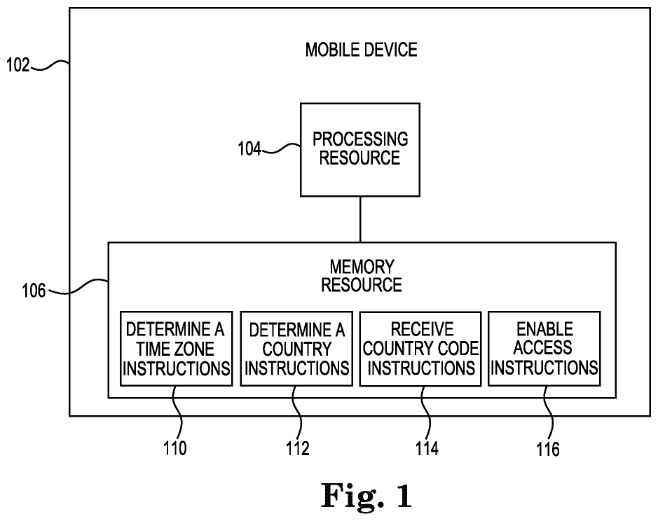

FIG. 1 illustrates a diagram of an example of a mobile device 102 consistent with the disclosure. Mobile device 102 can include a processing resource 104 and a memory resource 106. Memory resource 106 can include machine-readable instructions, including determine a time zone instructions 110, determine a country instructions 112, receive country code instructions 114, and enable access instructions 116.

Processing resource 104 may be a central processing unit (CPU), a semiconductor based microprocessor, and/or other hardware devices suitable for retrieval and execution of machine-readable instructions 110, 112, 114, 116 stored in a memory resource 106. Processing resource 104 may fetch, decode, and execute instructions 110, 112, 114, 116. As an alternative or in addition to retrieving and executing instructions 110, 112, 114, 116, processing resource 104 may include a plurality of electronic circuits that include electronic components for performing the functionality of instructions 110, 112, 114, 116.

Memory resource 106 may be any electronic, magnetic, optical, or other physical storage device that stores executable instructions 110, 112, 114, 116 and/or data. Thus, memory resource 106 may be, for example, Random Access Memory (RAM), an Electrically-Erasable Programmable Read-Only Memory (EEPROM), a storage drive, an optical disc, and the like. Memory resource 106 may be disposed within mobile device 102, as shown in FIG. 1. Additionally and/or alternatively, memory resource 106 may be a portable, external or remote storage medium, for example, that allows mobile device 102 to download the instructions 110, 112, 114, 116 from the portable/external/remote storage medium.

Processing resource 104 may execute determine a time zone instructions 110 stored in memory resource 106 to determine a time zone from an operating system (OS) of mobile device 102, and determine a country of mobile device 102 based on the time zone of the OS of mobile device 102. As used herein, a time zone refers to a specified region of the Earth that observes a uniform standard time for legal, commercial, and/or social purposes. A time zone may be offset from the Coordinated Universal Time (UTC).

The time zone of mobile device 102 can be determined from an operating system of mobile device 102. An operating system of mobile device 102, as used herein, can be software that manages hardware (e.g., processing resource 104, memory resource 106) and software resources and can provide common services for mobile device 102 programs. The time zone of mobile device 102 can be determined by converting the system time of the operating system (e.g., Coordinated Universal Time) of mobile device 102 to a local time zone of the country of mobile device 102, such as the Eastern Time Zone located in the United States.

In some examples, the time zone of mobile device 102 can be set by a manufacturer and/or a wireless service provider of mobile device 102. In some examples, a manufacturer of mobile device 102 to be sold in the United States can set the time zone of the mobile device to the Eastern Time Zone, located in the United States. In some examples, a wireless service provider can set the time zone of mobile device 102 included as part of a wireless service agreement to correspond to the coverage area provided by the wireless service provider, such as the United States.

In some examples, the time zone of mobile device 102 can be set by a user when powering on mobile device 102. For instance, mobile device 102 can prompt a user to set the time zone of mobile device 102 according to the user's country. The user prompt can occur when the user turns on mobile device 102 for a first time. However, examples of the disclosure are not so limited. For example, mobile device 102 can prompt a user to set the time zone of mobile device 102 after a set time period, after a predetermined amount of boot sequences of mobile device 102, and/or after any other action or period of time.

Processing resource 104 may execute determine a country instructions 112 stored in memory resource 106 to determine a country of mobile device 102 based on the time zone of the OS of mobile device 102. For example, mobile device 102 may determine mobile device 102 is in the United States based on the time zone of the OS of mobile device 102 being the Eastern Time Zone.

Processing resource 104 may execute receive country code instructions 114 stored in memory resource 106 to receive respective country codes from APs in communication with mobile device 102. As used herein, an access point can refer to a device with a range of communication access that can allow a mobile device to connect to a wired network through the access point via a network relationship while the location of the mobile device is within the range of communication access of the access point.

Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, the Internet, and/or any other wireless communication standard using IEEE 802.11ad and/or IEEE 802.11ay protocols. For example, a mobile device within the range of communication access of an access point can connect to a wired network by wirelessly connecting (e.g., via a WLAN) to the access point associated with the wired network.

As used herein, a country code refers to a code which indicates a country the access point is located in. For example, an access point located within the United States can broadcast a country code indicating the access point is located within the United States. As another example, an access point located within China can broadcast a country code indicating the access point is broadcasting within China.

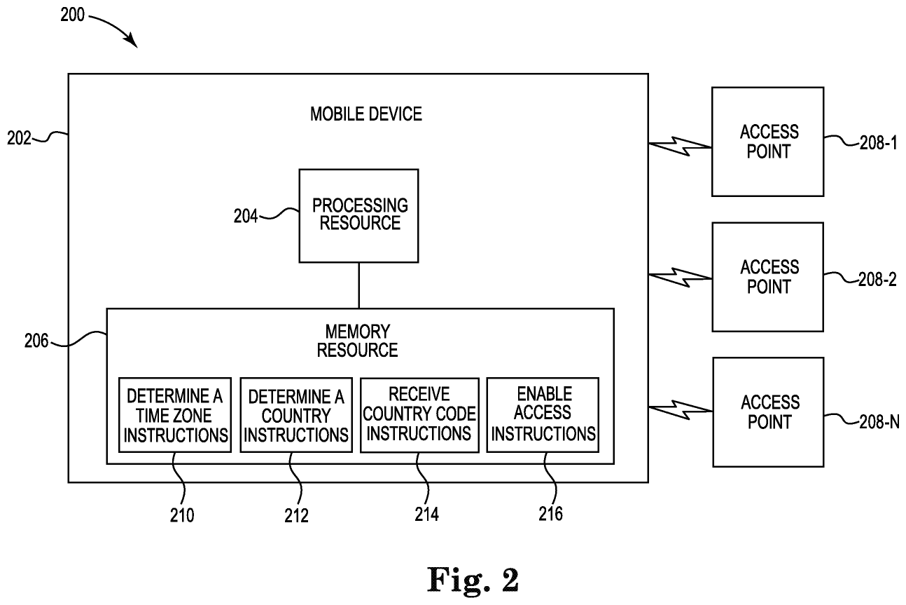

Processing resource 104 may execute enable access instructions 116 stored in memory resource 106 to enable access to an alternate radio channel from a default radio channel based on a comparison of the country of mobile device 102 and the country codes, as is further described herein with respect to FIG. 2. As used herein, a radio channel refers to a pathway or medium for communication of data from one location to another location.

In some examples, channel two of the 60 GHz frequency band can be the default radio channel. For example, mobile device 102 can operate in channel two of the 60 GHz frequency band until mobile device 102 can enable alternate radio channels, as is further described herein.

Access to an alternate radio channel by mobile device 102 may be enabled based on a country of mobile device 102. Different countries may allow different channels for use by mobile device 102. For example, mobile device 102 may be utilizing a 60 GHz frequency band based on IEEE 802.11ad or IEEE 802.11ay protocols, among other possible 802.11 protocols. A default channel for the 60 GHz band may be channel two. However, different countries may have varying regulations for usage of channels one, three, and/or four in the 60 GHz band. For instance, the United States may allow usage of channels one, two, and/or three in the 60 GHz band, whereas China may allow usage of channels two and/or three, but not channels one or four.

FIG. 2 illustrates a diagram of an example of a system 200 suitable for radio channel access based on country codes consistent with the disclosure. System 200 can include mobile device 202 (e.g., mobile device 102, previously described in connection with FIG. 1) and access points (APs) 208-1, 208-2, 208-N (referred to collectively as APs 208). Mobile device 202 can include a processing resource 204 (e.g., processing resource 104, previously described in connection with FIG. 1) and memory resource 206 (e.g., memory resource 106, previously described in connection with FIG. 1). Memory resource 206 can include machine-readable instructions, including determine a time zone instructions 210 (e.g., determine a time zone instructions 110, previously described in connection with FIG. 1), determine a country instructions 212 (e.g., determine a country instructions 210, previously described in connection with FIG. 1), receive country code instructions 114 (e.g., receive country code instructions 214, previously described in connection with FIG. 1), and enable access instructions 116 (e.g., enable access instructions 216, previously described in connection with FIG. 1).

Mobile device 202 can determine a country of mobile device 202 based on a time zone from an OS of mobile device 202. As described in connection with FIG. 1, the time zone can be determined by converting the system time of the OS to a local time zone of the country of mobile device 202. For example, mobile device 202 may convert the system time of the OS of mobile device 202 to a local time associated with the Eastern Time Zone. Based on the local time being associated with the Eastern Time Zone, mobile device 202 can determine that the country of mobile device 202 is the United States.

Mobile device 202 can determine a country of mobile device 202 based on a language setting of the OS of mobile device 202. A language setting can be determined based on the language being used by the OS of mobile device 202. For example, based on the language of the OS of mobile device 202 being English, and the time zone of mobile device 202 being the Eastern Time Zone, mobile device 202 can determine that the country of mobile device 202 is the United States.

Mobile device 202 can receive country codes included in beacon frames transmitted from APs 208 identifying a country from which APs 208 are broadcasting. As used herein, a beacon frame refers to a management frame in IEEE 802.11 based WLANs. A frame can include information about a network and may be periodically transmitted by an AP to announce the presence of a WLAN. For example, APs 208 may transmit beacon frames every 100 milliseconds (ms), among other possible beacon frame intervals.

A country code may be included in a beacon frame as a hexadecimal country code string in American Standard Code for Information Interchange (ASCII) format. For example, mobile device 202 may receive a beacon frame from APs 208 showing a hexadecimal country code string, such as “07 06 55 53 20 01 0b 10”. However, examples of the disclosure are not limited to a hexadecimal country code string in ASCII format. For instance, mobile device 202 may receive a beacon frame from APs 208 including a country code shown as alphabetic characters, such as “AU” as a country code identifying a country as being Australia

The country codes of APs 208 can identify a unique country from which APs 208 are broadcasting. For instance, continuing with the example beacon frame above, 07 can indicate the beacon frame is being used for country information, and 55 53 indicates the country code is “US”. Based on the country code being “US”, mobile device 202 can determine that APs 208 are broadcasting from the United States.

Mobile device 202 may compare the country codes of APs 208 included in a table of country codes stored on mobile device 202 to identify the respective country from which each APs 208 are broadcasting. For instance, a table of country codes may be stored in memory resource 206 of mobile device 202. Mobile device 202 can compare the country code received from APs 208 with country codes stored in the table of country codes to identify the country from which APs 208 are broadcasting. For example, mobile device 202 can receive a country code showing “US”, and using the table of country codes stored in memory resource 206, determine that the country code showing “US” indicates the APs 208 are broadcasting from the United States.

Although shown in FIG. 2 as including three APs, examples of the disclosure are not so limited. For example, system 200 may include four or more APs, and country codes may be received from the four or more APs.

In an example in which mobile device 202 receives country codes from the plurality of APs, mobile device 202 can enable access to alternate radio channels from the default radio channel using three APs with the highest received signal strength indicator (RSSI) value of the plurality of APs. For instance, mobile device 202 may receive respective country codes from AP 208-1, 208-2, 208-N, and two other APs. In some examples, mobile device 202 can determine that APs 208-1, 208-2, and 208-N have the three highest RSSI values of the five total APs, and use the respective country codes from APs 208-1, 208-2, 208-N to enable access to the alternate radio channels based on a comparison of the country of the mobile device and respective countries corresponding to the country codes, as is further described herein. The country of mobile device 202 may be determined based solely on a time zone of mobile device 202, or based on the time zone and a language setting of mobile device 202.

As described above, mobile device 202 may utilize a signal strength of an access point, such as an RSSI measurement. As used herein, RSSI can be a relative received signal strength in a wireless environment (e.g., WLAN). For example, an access point having a higher RSSI number can have a stronger signal than a different access point having a lower RSSI number.

Although signal strength of an access point is described as being indicated using an RSSI measurement, examples of the disclosure are not so limited. For example, the signal strength of an access point can be indicated using any other method for measuring the strength of a wireless signal.

In some examples, less than three APs may have the same country codes. For example, APs 208-1 and 208-2 may indicate they are broadcasting in the US, and AP 208-N may indicate it is broadcasting in Canada. In response to less than three APs having the same country codes, mobile device 202 can refrain from enabling access to alternate radio channels from the default radio channel.

Mobile device 202 can enable access to alternate radio channels from a default radio channel when respective countries of three APs 208 are the same as the country of the mobile device. For example, mobile device 202 may be operating in the 60 GHz frequency band, where the 60 GHz frequency band includes four channels. Channel two may be the default channel, and mobile device 202 can enable access to channels one, three, and/or four when respective countries of three APs 208 are the same as the country of mobile device 202.

Although described as enabling access to alternate radio channels from a default radio channel when respective countries of three APs 208 are the same as the country of the mobile device, examples of the disclosure are not so limited. For instance, mobile device 202 can enable access to alternate radio channels from a default radio channel when respective countries of more than three APs 208 are the same as the country of the mobile device.

The alternate radio channels can be compliant with radio channel usage regulations of the country of mobile device 202. Continuing with the example above, mobile device 202 may operate by default on channel two in China, and based on three APs 208 having country codes indicating APs 208 are broadcasting from China, and the country of mobile device 202 being China, mobile device 202 may enable channel three as an alternate channel.

In some examples, mobile device 202 can enable access to alternate radio channels from the default radio channel when respective countries of three APs 208 are the same as the country of mobile device 202. For example, mobile device 202 may determine the time zone from the OS of mobile device 202 to be Beijing Time Zone, the language setting of the OS is Chinese, and the country codes from the three APs 208 all identify China. Based on the Beijing Time Zone and the Chinese language setting of the OS, mobile device 202 may determine that in the country of mobile device 202 is China, and that the three APs 208 all identify China. In response, mobile device 202 can enable access to channel three in the 60 GHz frequency band for mobile device 202 for communication.

Three APs 208 having the same country codes can enable access to alternate radio channels from the default radio channel. For instance, all three APs 208 including country codes identifying China as the country for all three APs 208 can allow access by mobile device 202 to alternate radio channels from the default radio channel.

In some examples, less than three APs 208 may have the same country code. For instance, AP 208-1 and 208-2 may include country codes identifying the country of AP 208-1 and 208-2 as China, and AP 208-N may include a country code not identifying the country of AP 208-N as China. In response to a country of an AP 208-N of the APs 208 being different from the country codes of AP 208-1 and 208-2, mobile device 202 can refrain from enabling access to the alternate radio channels from the default radio channel.

As previously described, mobile device 202 can operate in a 60 GHz frequency band. Mobile device 202 may disable the 60 GHz frequency band in response to the country of mobile device 202 being a country disallowing use of the 60 GHz frequency band. For example, mobile device 202 may determine the time zone from the OS of mobile device 202 to be Moscow Time Zone and/or the language setting of the OS is Russian. Based on the Moscow Time Zone or based on the Moscow Time Zone and the Russian language setting of the OS, mobile device 202 may determine that the country of mobile device 202 is Russia. If Russia disallows the use of the 60 GHz frequency band, mobile device 202 can disable the 60 GHz frequency band. Mobile device 202 may use a 2.4 GHz frequency band or a 5 GHz frequency band in lieu of the 60 GHz frequency band, among other possible frequency bands.

Radio channel access based on country codes can allow a mobile device to utilize alternate channels for communication. Enabling alternate channels by using country codes can allow for compliance with channel regulations in many different countries around the world.

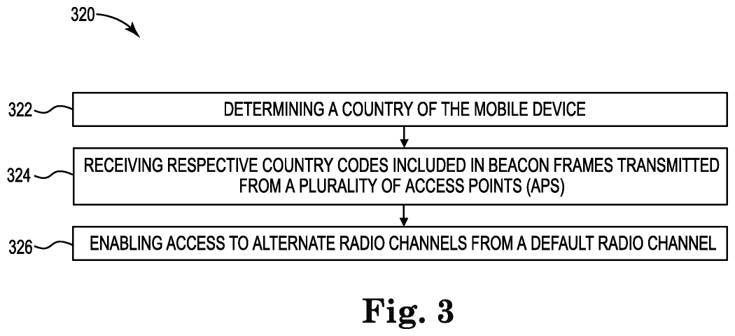

FIG. 3 illustrates an example of a method 320 for radio channel access based on country codes consistent with the disclosure. For example, method 320 can be performed by a mobile device (e.g., mobile device 102, 202, previously described in connection with FIGS. 1 and 2, respectively) to provide radio channel access based on country codes.

At 322, the method 320 includes determining a country of the mobile device. In some examples, the country of the mobile device may be determined by the mobile device based on a time zone of the mobile device from an OS of the mobile device. In some examples, the country of the mobile device may be determined based on a time zone of the mobile device from an OS of the mobile device and a language setting of the mobile device from the OS of the mobile device.

At 324, the method 320 includes receiving respective country codes included in beacon frames transmitted from a plurality of APs. The country codes included in the beacon frames received by the mobile device can identify a unique country from which each AP is broadcasting. In some examples, a country code from a first AP may indicate the first AP is broadcasting in the United States, and a country code from a second AP may indicate the second AP is broadcasting in Canada. In some examples, a country code from a first AP may indicate the first AP is broadcasting in the United States, and a country code from a second AP may indicate the second AP is broadcasting in United States.

At 326, the method 320 includes enabling access to alternate radio channels from a default radio channel. The mobile device can enable access to the alternate radio channels when the respective countries of three APs are the same as the country of the mobile device. The mobile device can refrain from enabling access to the alternate radio channels in response to less than three APs having the same country codes.

Method 320 may be repeated at a predetermined and/or configurable interval. For instance, method 320 may be repeated at the interval to determine whether to enable access to alternate radio channels from the default radio channel. The interval may be subject to regulation based on the country of the mobile device. That is, the interval can be compliant with a country's regulations. For example, based on FCC restrictions in the United States, the interval can be one hour, or more frequent than one hour. However, based on the FCC regulations, the interval may not be longer than one hour.

Method 320 may be repeated in response to the time zone of the mobile device being modified. For instance, a user of the mobile device may travel with the mobile device from a first time zone to a second time zone. In some examples, the user may modify the time zone of the mobile device from the first time zone to the second time zone. In some examples, the OS of the device may modify the time zone of the mobile device from the first time zone to the second time zone. In response to the time zone of the device being modified, method 320 may be repeated to determine whether to enable access to alternate radio channels from the default radio channel.

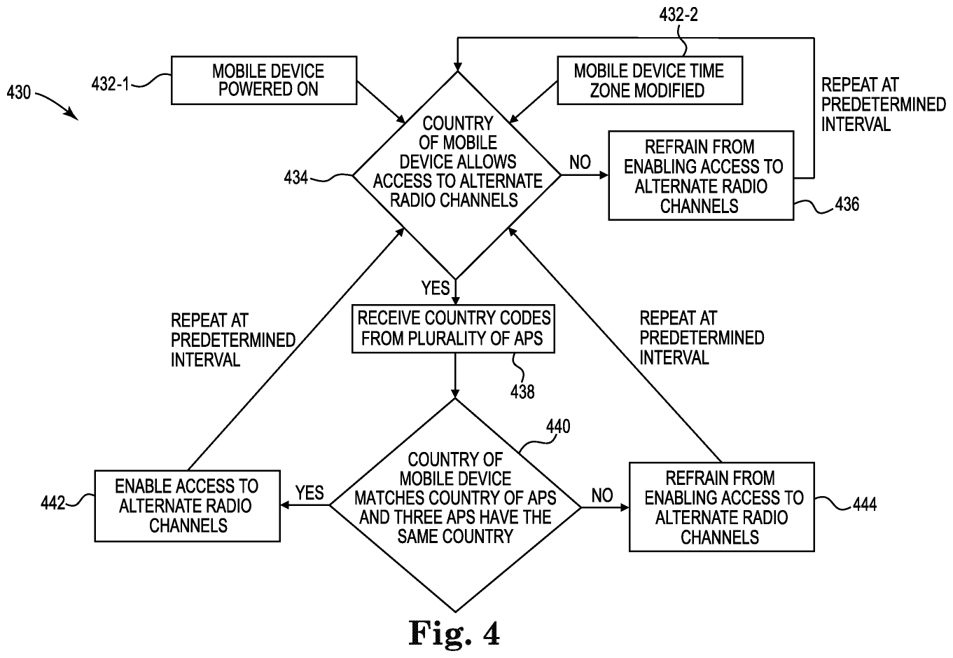

FIG. 4 illustrates an example flow chart 430 for radio channel access based on country codes consistent with the disclosure. At 434, a mobile device (e.g., mobile device 102, 202, described in connection with FIGS. 1 and 2, respectively) may determine whether a country of the mobile device allows access to alternate radio channels. The mobile device may determine a country of the mobile device based on a time zone from an OS of the mobile device, or based on the time zone from the OS and a language setting of the OS of the mobile device.

In some examples, at 432-1, the mobile device can determine the country of the mobile device in response to the mobile device being powered on. For instance, the mobile device can determine the country of the mobile device, and determine whether the country allows access to alternate radio channels.

In some examples, at 432-2, the mobile device can determine the country of the mobile device in response to the mobile device time zone being modified, For instance, the time zone of the OS of the mobile device may be modified, and the mobile device can determine the country of the mobile device and determine whether the country allows access to alternate radio channels in response to the modified time zone of the OS. The time zone may be modified in response to a user input, in response to a change in a location of the mobile device, etc.

At 436, the mobile device can refrain from enabling access to alternate radio channels in response to the country of the mobile device not allowing access to alternate radio channels. For example, based on the time zone of the OS being Moscow Time Zone, and/or the language setting of the OS being Russian, the mobile device can determine the country of the mobile device is Russia. In response to the country of the mobile device being Russia, the mobile device can determine Russia does not allow access to alternate radio channels and refrain from enabling access to the alternate radio channels.

434 may be repeated at a predetermined interval. For example, the mobile device may determine the country of the mobile device based on the time zone of the OS of the mobile device, or the time zone and the language settings of the OS of the mobile device after the predetermined interval. The predetermined interval may be one hour.

In response to the country of the mobile device allowing access to alternate radio channels, the mobile device can receive respective country codes from APs at 438. For example, the mobile device can receive a country code from a first AP, a country code from a second AP, etc., where the first and the second AP are in communication with the mobile device.

At 440, the mobile device can determine whether the country of the mobile device matches the country of the APs, and whether three APs have the same country. For example, the mobile device can determine whether the countries of three APs are all United States, and whether the country of the mobile device is the same as the countries of the three APs.

At 442, based on the mobile device determining the countries of all three APs are the United States, and the country of the mobile device is the United States, the mobile device can enable access to alternate radio channels. The mobile device may repeat the method of flow chart 430 after enabling access to alternate radio channels at a predetermined interval. For example, at the predetermined interval, the mobile device can determine whether the country of the mobile device allows access to alternate radio channels at 434, receive country codes from APs in response to the country allowing access to alternate radio channels at 438, and determine whether the country of the mobile device matches the country of the APs and whether three APs have the same country at 440.

At 444, based on the mobile device determining the countries of all three APs are not the United States (e.g., the countries of two APs of the three APs are the United States and the country of the third AP of the three APs is Canada), the mobile device can refrain from enabling access to alternate radio channels. The mobile device may repeat the method of flow chart 430 after refraining from enabling access to alternate radio channels at a predetermined interval. For example, at the predetermined interval, the mobile device can determine whether the country of the mobile device allows access to alternate radio channels at 434, receive country codes from APs in response to the country allowing access to alternate radio channels at 438, and determine whether the country of the mobile device matches the country of the APs and whether three APs have the same country at 440.

The predetermined interval may be configurable. For example, the interval may be subject to regulation based on the country of the mobile device (e.g., the interval can be one hour based on FCC restrictions in the United States). In response to the ease with which mobile devices may move globally, the predetermined interval may allow for the mobile device to quickly and easily enable or refrain from enabling access to alternate radio channels.

As used herein, “logic” is an alternative or additional processing resource to perform a particular action and/or element described herein. Logic can include hardware. The hardware can include processing resources such as circuitry, which are distinct from machine-readable instructions on a machine readable media. Further, as used herein, “a” can refer to one or more such things.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A mobile device, comprising:
a processing resource; and
a memory resource storing machine-readable instructions to cause the processing resource to:
determine a time zone from an operating system (OS) of the mobile device;
determine a country of the mobile device based on the time zone;
receive respective country codes from a plurality of access points (APs) in communication with the mobile device; and
enable access to an alternate radio channel from a default radio channel based on a comparison of the country of the mobile device to respective countries corresponding to the country codes.

2. The mobile device of claim 1, including instructions to cause the processing resource to identify a unique country from which each of the plurality of APs is broadcasting based on a comparison of the received country codes to a table of country codes stored on the mobile device.

3. The mobile device of claim 1, including instructions to cause the processing resource to enable access to the alternate radio channel when respective countries of the plurality of APs are the same as the country of the mobile device.

4. The mobile device of claim 3, including instructions to cause the processing resource to refrain from enabling access to the alternate radio channel in response to a country of an AP of the plurality of APs being different.

5. The mobile device of claim 1, including instructions to cause the processing resource to determine the country of the mobile device based on the time zone of the OS and a language setting of the OS.

6. The mobile device of claim 1, wherein access to the alternate radio channel by the mobile device is enabled based on the country of the mobile device.

7. A non-transitory machine-readable medium storing instructions executable by a processing resource to cause a mobile device to:
determine a country of the mobile device based on:
a time zone from an operating system (OS) of the mobile device; and
a language setting of the OS of the device;
receive respective country codes included in beacon frames transmitted from a plurality of access points (APs) identifying respective countries from which the plurality of APs are broadcasting;
enable access to alternate radio channels from a default radio channel when the respective countries of three APs of the plurality of APs are the same as the country of the mobile device.

8. The medium of claim 7, comprising instructions to enable access to the alternate radio channels from the default radio channel using three APs with the highest received signal strength indicator (RSSI) value of the plurality of APs.

9. The medium of claim 7, wherein the mobile device is operating in a sixty gigahertz (GHz) frequency band.

10. The medium of claim 10, comprising instructions to disable the sixty GHz frequency band in response to the country of the mobile device being a country disallowing use of the sixty GHz frequency band.

11. A method, comprising:
determining, by a mobile device, a country of the mobile device based on:
a time zone of the mobile device from an operating system (OS) of the mobile device; and
a language setting of the mobile device from the OS of the mobile device;
receiving, by the mobile device, respective country codes included in beacon frames transmitted from a plurality of access points (APs), wherein each of the country codes identify a respective country from which each AP is broadcasting; and
enabling, by the mobile device, access to alternate radio channels from a default radio channel when the respective countries of three APs of the plurality of APs are the same as the country of the mobile device.

12. The method of claim 11, wherein the alternate radio channels are compliant with radio channel usage regulations of the country of the mobile device.

13. The method of claim 11, wherein the method is repeated in response to the time zone of the mobile device being modified.

14. The method of claim 11, wherein the method is repeated at a predetermined and configurable interval.

15. The method of claim 14, wherein the predetermined interval is one hour.
